(19) United States
(12) Patent Application Publication
(10) Pub. No.: US 2011/0060652 A1
(43) Pub. Date: Mar. 10, 2011

(54) SYSTEM AND METHOD FOR THE SERVICE OF ADVERTISING CONTENT TO A CONSUMER BASED ON THE DETECTION OF ZONE EVENTS IN A RETAIL ENVIRONMENT

(76) Inventor: Timothy B. Morton, Kirkland, WA (US)

(21) Appl. No.: 12/557,383

(22) Filed: Sep. 10, 2009

(51) Int. Cl. G06Q 30/00; H04Q 5/22

(52) U.S. Cl. 705/14.58; 340/10.4

(57) ABSTRACT

A system and method for the delivery of targeted advertising content to a consumer based on the detection of region and zone events in a retail environment. The retail environment is divided into a number of detection regions, with each detection region monitored by a region manager and containing one or more display devices. Each display device has an associated display zone in which a consumer is likely to be exposed to advertising content that is being presented on the display device. The region manager can detect the location of the marker within the detection region. When a marker enters a display zone, the region manager makes an HTTP request to a session manager to deliver relevant advertisements. The session manager responds with an HTTP response that delivers advertising content to the display device that is contained in the display zone.

### BACKGROUND

The vast majority of advertising content is delivered to consumers at a time when consumers are not actively making a purchasing decision. For example, advertising content in the form of consumer promotions, such as coupons, are delivered in physical form via mail or in Free Standing Inserts (FSIs) in newspapers or other forms of published media. To be effective, these consumer promotions must not only be viewed by consumers—a daunting problem, given the size of newspapers, magazines and other print media—but must also generate a sufficient impression on consumers to cause consumers to change their purchasing behavior when later shopping at a retail store. Given the hurdles for consumer promotions to be successful, it is therefore not surprising that the vast majority of coupons are never actually redeemed and that return on advertising dollar spent can be quite small. As another example, the presentation of advertising on television has long been one of the most important channels for advertisers to reach consumers with advertising content. While advertisers may be more confident that consumers are actually being exposed to advertising content that is presented on television, consumers receive the content at a time when they are engaged in the passive activity of watching television programming. As with print ads, the advertiser must therefore count on the advertising content making a sufficiently large enough impression on consumers to cause consumers to later change their purchasing behavior at a point of purchase.

With the creation of the World Wide Web and the launch of commercial websites through which products and services could be purchase, some of the challenges of reaching consumers at a time when consumers are making a purchase decision changed. By advertising on websites, advertisers were suddenly able to target consumers based on the website that they are visiting, the products or services that they are looking at and considering purchasing, and other characteristics of the consumer, such as past purchases or express indications of preference. By moving advertising online and closer to a consumer's point of purchase, advertisers are able to have a greater impact on the purchasing behavior of consumers. A shortcoming of advertising on websites, however, is that only a small fraction of total purchase transactions are performed on the web. Most purchases are still completed in brick-and-mortar stores.

In sum, although websites have allowed advertisers to move closer to the point of purchase, the vast majority of advertising is still being delivered to consumers via print or television media at a time and location distant from the point of purchase. To date, no solution has been able to marry the effectiveness of online advertising to the inherent volume advantage provided by traditional brick-and-mortar retailers.

### BRIEF DESCRIPTION OF THE DRAWINGS

FIG. 1A is a perspective view of a retail environment containing display devices that display advertising content to consumers that are present in the retail environment.

FIG. 1B is an overhead view of a retail environment depicting detection regions and display zones that are mapped within the environment.

FIG. 1C is a front view of a representative display device that displays advertising content to a consumer.

FIG. 2 is block diagram of a system that detects indications of region and zone events associated with a consumer in a retail establishment and identifies relevant advertising content for presentation to the consumer on a display device.

FIG. 3 is a flow diagram of a process implemented by a region manager to detect a region or zone event associated with a consumer and generate various HTTP requests to a session manager, such as a request for the delivery of relevant advertising content to a display device in response to a zone event.

FIGS. 4A-4C are flow diagrams of processes implemented by the session manager to receive and process region or zone events that are sent by the region manager.

FIG. 5 is a flow diagram of a process implemented by the session manager to select relevant advertising content for presentation to a consumer based on a received HTTP request.

FIG. 6 is a flow diagram of a process that is executed by the display device to receive an HTTP response from the session manager and present the selected advertising content on the display device to a consumer.

FIG. 7 is a representative session log for storing session data associated with the region and zone events of a consumer.

### DETAILED DESCRIPTION

A system and method for the automatic delivery of targeted advertising content to a consumer based on the detection of zone events in a retail environment. The retail environment is divided into a number of detection regions, with each detection region monitored by a region manager and containing one or more display devices. Each display device has an associated display zone in which a consumer is likely to be exposed to advertising content that is being presented on the display device. Each display zone is associated with one or more products or categories of products. Markers, such as a radio frequency identification (RFID) tag, RuBee tag, or other tag, are associated with consumers that are visiting the retail environment. Each region manager can detect when a marker enters a detection region and when a marker leaves a detection region. Moreover, the region manager can detect the location of the marker within the detection region. When the detected location of the marker indicates that the marker has entered a display zone, the region manager makes a request to a session manager to deliver relevant advertisements for presentation to the consumer that is associated with the marker. The session manager responds with a response that delivers advertising content to the display device that is contained in the entered display zone. The delivered advertising content is targeted to the consumer based on the particular products or categories of products contained in the zone. The delivered advertising content may also be targeted to the consumer based on known information about the consumer, such as past purchases or shopping behavior observed during the present or prior shopping sessions. The consumer is thereby presented with a very timely and targeted advertising message at the exact time when the consumer is making a purchase decision at the retail establishment.

In some embodiments, the request made by the region manager is a Hypertext Transfer Protocol (HTTP) request, and the response delivered by the session manager is an HTTP response. By using requests and responses formatted in accordance with the HTTP protocol, the disclosed system may easily integrate with existing advertising services or content that is available via the Internet or other networks. In some embodiments, rather than transmit an HTTP request, the region manager transmits a short message service (SMS) request or an ICQ request and receives responses from the session manager via a corresponding messaging protocol. By using requests and responses formatted in accordance with common messaging protocols, the disclosed system may easily integrate with existing advertising services or content that are available via mobile messaging platforms.

In some embodiments, the session manager maintains a session log that stores all region and zone events associated with a consumer's visit to a retail establishment. The session log contains a record of all regions and zones that the consumer visited, certain actions the consumer performed in each zone, and subsequent purchases that the consumer made as part of a check out process. The session log may be used by the session manager to better target advertisements that are delivered to the consumer during the visit. Moreover, for those consumers that are capable of being tracked across visits (e.g., when a marker is semi-permanently associated with a consumer, such as when the marker is embedded in a store loyalty card), the session log may be stored by the session manager and a profile of the consumer's preferences constructed over time.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

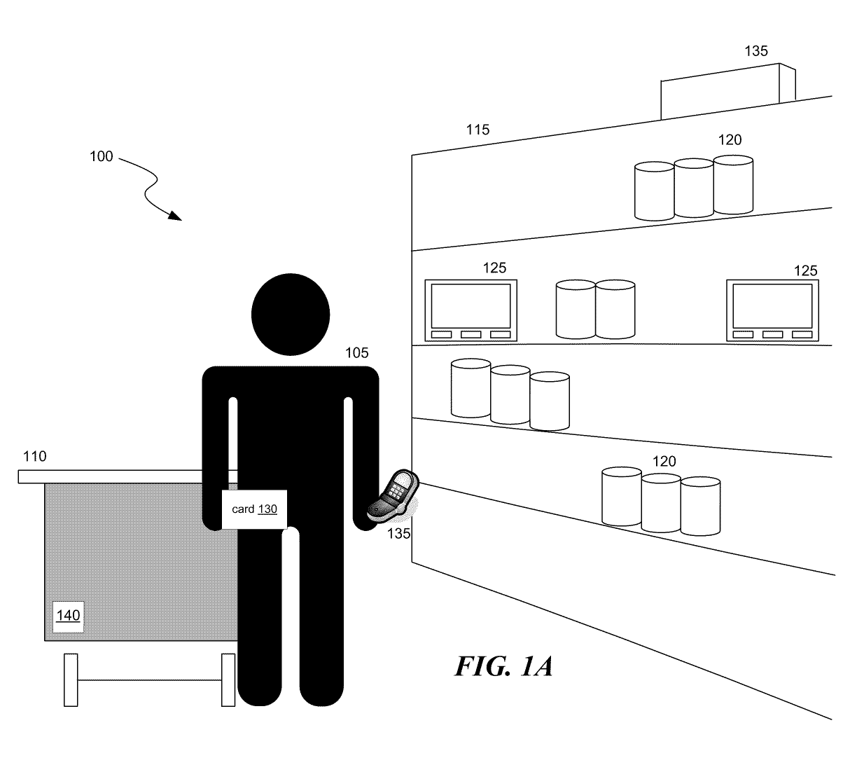

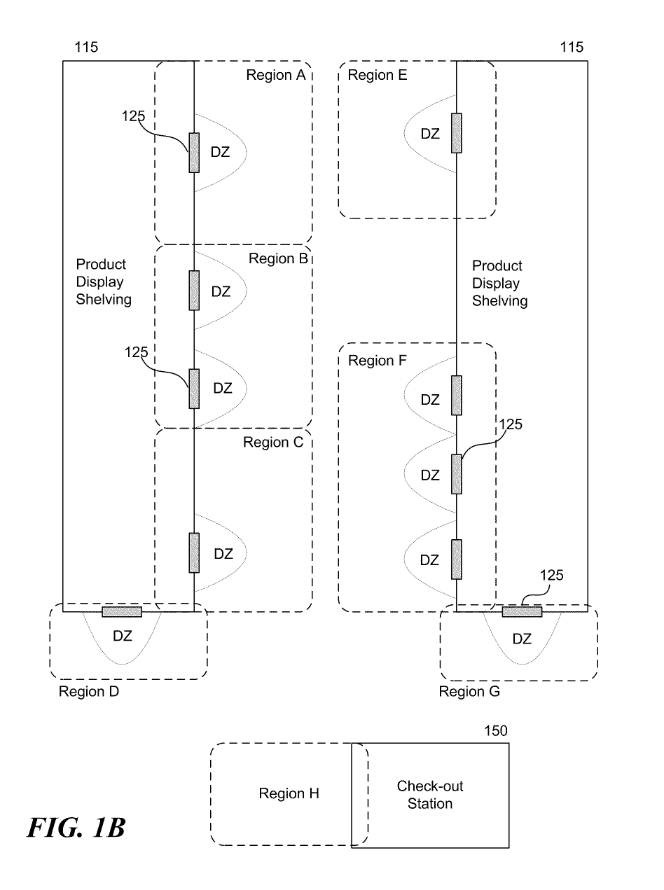

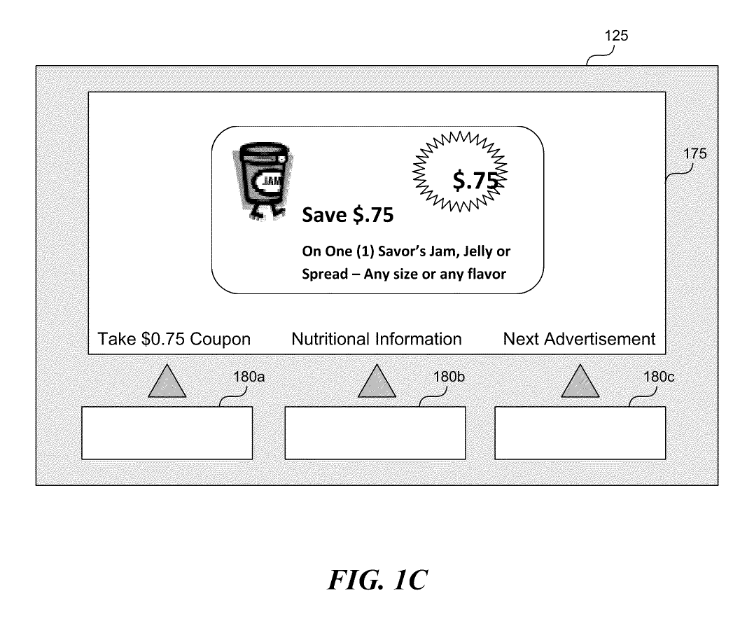

FIG. 1A is a perspective view of a retail environment 100 containing display devices 125 that present advertising content to consumers 105 that are visiting the retail environment. The retail environment may be any environment in which consumers purchase products, such as a grocery store, a drug store, an office supply store, a hardware store, an auto parts store, etc. Such retail environments normally have one or more rows of shelving 115 that allow the retailer to display various products 120 that are available for purchase by the consumer. To facilitate the purchase of products, the retailer may offer shopping carts 110 or other baskets or tote bags (not shown) that allow the consumer to carry those products that are intended to be purchased. When a consumer has selected all of the products that are to be purchased, the consumer typically proceeds to a check-out register, payment kiosk, or other check-out location to pay for the purchases.

Deployed within the retail environment 100 is a system that allows advertising content to be displayed to consumers in a targeted and trackable manner. The retail environment 100 is divided into a number of detection regions and display zones. As will be described in additional detail herein, a detection region is a region in which the presence of a marker associated with a consumer may be detected and the location of the marker in the detection region determined. The size of each detection region is determined by the monitor technology used to detect the presence and location of a marker. Within or adjacent to each detection region are one or more display zones. Each display zone is a region in proximity to a display device 125 in which a consumer is likely to be exposed to advertising content that is presented on the display device. The size of each display zone is dependant on such factors as the size and quality of the corresponding display device, the particular advertising content that is presented on the display, and the presence or absence of any obstructions around the display. Each display zone is associated with one or more products or categories of products that are available at the retail establishment. A display zone is typically associated with those products or categories of products that are located in proximity to the display device, since those are the product or categories of products that a consumer is in the process of purchasing when viewing advertisements on the display device.

FIG. 1B is an overhead view of a retail environment depicting detection regions and display zones that are mapped within the environment. Two sets of product shelving 115 or product displays are displayed, as well as a check-out station 150 that a consumer would visit to pay for any purchases. The aisle between the shelving 115 is divided into a number of detection regions of equal or different sizes. For example, in the depicted environment, the area around one set of product shelving is divided into four detection regions (Regions A-D) and the area around the other set of product shelving is divided into three detection regions (Regions E-G). While some detection regions (Regions A-C, E-F) extend into the aisle formed by the shelving, other detection regions (Regions D, G) extend beyond end-aisle displays. In addition, a Region H is defined near the check-out station 150 to detect the presence of consumers at the check-out station. Detection regions may be deployed in a contiguous fashion so that all or most of the shoppable area in the environment is covered by a region, or detection regions may be scattered throughout the environment in a non-contiguous fashion (e.g., Regions E and F are separated by a section of aisle that is not contained in any detection region). By appropriate layout of detection regions, the system is able to detect the location and path of travel of markers within the retail environment.

Each detection region contains one or more display devices 125 that display advertising content to the consumer. For example, Region A contains a single display device, Region B contains two display devices, and Region F contains three display devices. Each display device has a surrounding display zone (“DZ”) in which a consumer is likely to be exposed to advertising content that is being presented on the corresponding display device. Although all of the display zones in FIG. 1B are depicted as being of a similar size, it will be appreciated that the size of each display zone may vary depending on the size and quality of the corresponding display device 125, and the other factors previously mentioned herein.

Returning to FIG. 1A, each region is monitored by a region manager 135. As will be described in additional detail herein, the region manager 135 is able to detect when a marker associated with a consumer 105 enters the region monitored by the manager. The region manager 135 is also able to detect the location of the marker within the region. A “marker” is any technology component that allows the presence and location of the marker to be detected within a desired accuracy in the retail environment. For example, a marker may be a passive tag, such as a radio frequency identification (RFID) tag that operates in in the VHF, UHF or SHF bands. As another example, the marker may be an active tag, such as certain RFID tags or RuBee (IEEE 1902.1) tags that operate in the LF band. Alternatively, the marker may incorporate components that allow the location of the marker to be detected using local wireless network signals or global positioning signals. For example, the location of the marker may be determined by triangulating from local Bluetooth, ZigBee, WiFi, WiMax, cellular or other personal, local, or wide area wireless network signals that are detected by the marker or which can detect the marker. As another example, the marker may incorporate an assisted global position system (A-GPS) receiver so that the marker can compute its location based on received A-GPS signals. On a periodic or aperiodic basis the marker or other wireless network components transmit the marker's location to a region manager.

The marker may be embedded in or attached to a card 130 (e.g., a store loyalty card, a credit card, a driver's license, etc.) that this associated with the retail environment and carried by the consumer, the marker may be embedded in an identification component 140 that is attached to the shopping cart 110, basket, or bag carried by the consumer, or the consumer may have a marker attached to or embedded in a mobile phone 135 or other portable device that is carried by the consumer (e.g., in a SIM card that is inserted into a mobile phone or other device). The marker may be permanently affixed or embedded within the card (e.g., in a store loyalty card), carrying apparatus or device, or the marker may be temporarily affixed (e.g., by the use of a sticker or other semi-permanent means to affix a marker to a credit card, driver's license, or mobile device). The marker may be permanently associated with the consumer, such as a marker on a driver's license, store loyalty card, or phone that is carried by the consumer during multiple visits. Alternatively, the marker may be temporarily associated with the consumer, such as with a shopping cart, basket, or bag that is used by the consumer only during a particular visit to the retail environment.

When the region manager 135 detects the presence of a marker in the associated detection region, a message is sent to a session manager indicating that the marker has entered the region. When the region manager 135 further determines that the marker has entered a display zone in proximity to a display device 125, a message is sent to the session manager requesting the delivery of advertising content for display to the consumer. In response to the request, the session manager selects and transmits advertising content to the associated display device 125 where it is presented to the consumer. The advertising presented to the consumer relates to the one or more products or categories of products 120 that are contained in or associated with the corresponding display zone. Since the region manager requests advertising content when a marker is detected in the display zone, the advertising content may be selected so that it is targeted to the consumer. Moreover, the advertising content may also be selected so that it represents the most recent or up-to-date advertising that is available for the associated one or more products or categories of products. Also, since the advertising content is delivered to the consumer at the time that the consumer is making a purchase decision, the effectiveness of the advertising content will typically be significantly better than advertising delivered in other channels to the consumer.

FIG. 1C is a front view of a representative display device 125 that presents advertising content to a consumer. Advertising content may be text, images, or video, or any combination thereof, and may or may not include associated audio. The advertising content that is presented to consumers is anything that an advertiser feels will be beneficial to the sale of products. For example, advertising content may include a commercial for a product, nutritional information about the product, suggested recipes that incorporate the product, recommendations of other products that may be used in conjunction with the product, and coupons or rebates for the product. The display device 125 includes one or more buttons or other controls that allow the consumer to interact with information on the display device. For example, if the advertising content is a coupon that is displayed to a consumer, the consumer may select the coupon by pressing a button 180a on the display device. As another example, the consumer may be interested in seeing nutritional information about a displayed product. The consumer may therefore press a button 180b to cause nutritional information to be requested and presented on the display device. To view additional advertisements on the display device, the consumer may also select a “next advertisement” button 180c. Selecting the next advertisement button causes the display to present another advertisement to the consumer. While three buttons 180 are depicted on the display device 125, it will be appreciated that a greater or lesser number of buttons or other controls may be present on the display device. In some embodiments, the display device has a touch screen display that allows a consumer to touch regions of the display in order to select a desired option. In some embodiments, no buttons are contained on the display device and the consumer cannot interact with the display device other than by being exposed to the presented advertising.

When the region manager 135 determines that the marker has left the display zone, the region manager notifies the session manager and the presentation of the advertising on the display device is halted unless other markers remain in the display zone. When the region manager 135 detects that the marker is no longer in the associated detection region, a message is sent to the session manager indicating that the marker has left the region. As will be described in detail herein, the indications sent by the region manager 135 to the session manager that a marker has entered and left a detection region and zone enable the system to track and predict of a path of the marker thought the retail establishment.

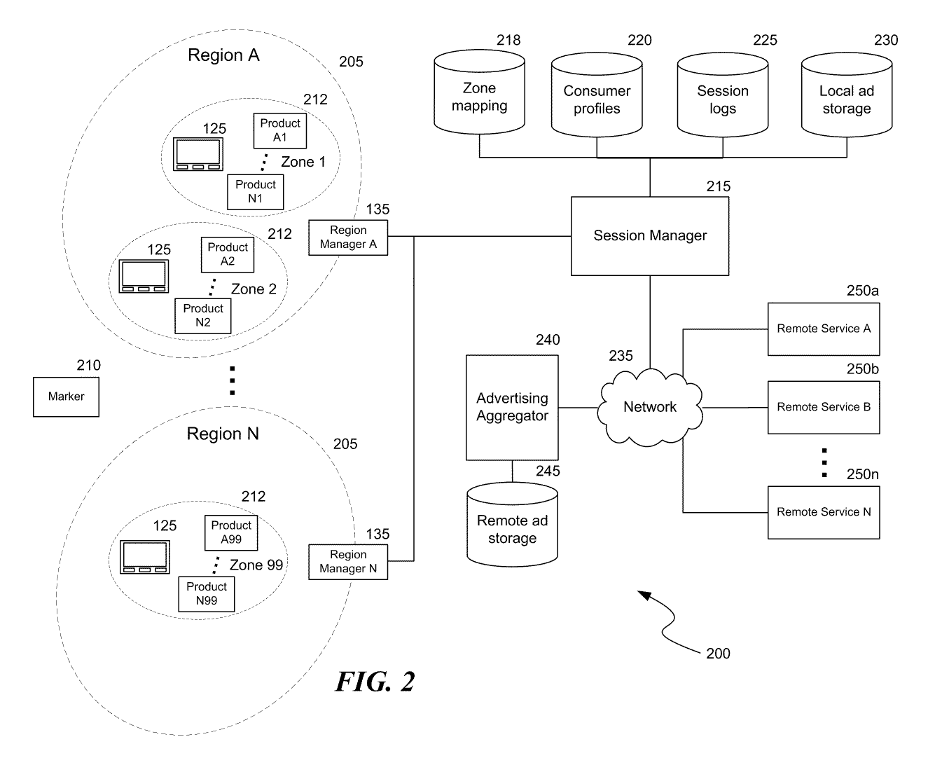

FIG. 2 is block diagram of a system 200 that detects region and zone events associated with a marker 210 in a retail establishment and identifies relevant advertising content for presentation to a consumer on one or more display devices 125. As depicted in FIG. 2, the system includes a number of region managers 135. Each region manager 135 includes a monitor that is capable of detecting markers 210 that enter into an area in proximity of the region manager. Such a detection area is referred to herein as a “detection region” 205 or simply region (e.g., Region A through Region N in FIG. 2). The monitor technology is selected such that the defined region 205 is of a generally-known size and limited range, allowing multiple regions to be deployed adjacent to one another in the retail environment. For example, the monitor may be a radio frequency identification (RFID) reader operating to read RFID tags. Depending on the selected type and frequency of RFID tag utilized, a defined zone may extend outward from 0.1 to 15 meters from a zone manger. Alternatively, the monitor may be a RuBee reader operating to read RuBee tags. Other examples of potential monitoring technologies include any short range communication technology (e.g., NFC, Bluetooth) that allows the region manager to receive position information that is transmitted by the marker. In addition to detecting when a marker enters a corresponding region, each region manager 135 is able to detect when the marker leaves the region.

In addition to being able to detect when a marker enters and leaves a detection region, the region manager 135 is also able to detect a location of the marker within the region. For example, the region manager may use ultra wideband (UWB) radio sensors sold by Time Domain Corporation of Hunstsville, Ala. (timedomain.com) and designed to detect the location of PLUS asset tags within the retail environment. As another example, the region manager may be an RFID-radar™ system manufactured by Trolley Scan (Pty) Ltd of Johannesburg, South Africa. Such a system is able to detect the presence, angle, and distance of an RFID tag from a reader antenna. As another example, the marker may contain a component that is able to determine the marker's location by triangulation (or other location-calculation technique) on signals from local wireless networks, such as WiFi, WiMax, WLAN, or cellular network signals. Examples of such a system that allows triangulation based on local wireless network signals are manufactured and distributed by AeroScout of Redwood City, Calif., Ekahau of Reston, Va., and Metrix Communication LLC of Seattle, Wash. As still another example, the marker may contain an assisted global positioning system (A-GPS) module that allows the marker to determine its location from A-GPS signals. The marker may then transmit the position to the region manager on a periodic or aperiodic basis via a short range communication protocol. Such a system to enable the detection and use of GPS signals in a retail environment is manufactured and distributed by u-blox AG of Swizerland or Alanco of Scottsdale, Ariz. While the location accuracy of the disclosed systems varies, the systems typically allow the location of a marker to be detected with sub-meter accuracy.

Within each detection region 205 are one or more display device devices 125. As previously noted, the display devices are capable of presenting advertising content to consumers. Display devices 125 may be low power devices, such as e-ink or e-paper displays, that are capable of operating on a self-contained power source such as a rechargeable battery. Alternatively, display devices may be higher-power displays, such as LCD, LED, OLED, QLED, or any other display technology, that requires connection to a power supply in the retail environment.

Each display device has an associated display zone 212, which is an area around the display device in which consumers will likely be exposed to advertising content if they are in the zone at the time that the advertising content is present. Each region manager 135 maintains records of the number and location of the display devices 125 that are contained in the detection region monitored by the region manager. The region manager 135 also maintains records of the display zone associated with each display device, including the relative size and position of the display zone with respect to the corresponding display and the detection region. The location of the display devices and zones may be stored in a data storage area, and updated on a periodic or aperiodic basis by the session manager. For example, the session manager may distribute a new mapping of display zones to detection regions when the owner of a retail environment changes the layout of shelving units, when display devices are repositioned on the shelving units, when changes are made to the type of installed display device, etc.

By maintaining a record of the size and position of each display zone within the detection region, and then tracking the location of each marker as it moves within the detection region, the region manager 135 is able to detect when a marker enters and leaves a display zone of a display device. The region manager does so by comparing the current location of a marker with the locations of display zones in a detection region in order to determine whether the current location indicates that the marker has entered, remains inside, or has exited the display zone.

Each display zone 212 encompasses one or more products or categories of products that are contained on retail shelves or displays that are either in or adjacent to the zone. When delivering advertising on the corresponding display 125 within a zone, the advertising content is selected based on the one or more products or categories of products associated with the zone. For example, in Zone 99 of FIG. 2, products A3-N3 are depicted as being associated with the zone. One or more of the products A3-N3 may therefore be used to determine which advertising content should be delivered to the display device 125 in the zone. In contrast, Zone 1 is depicted as containing products A1-N1 and Zone 2 is depicted as containing products A2-N2. Products A1-N1 are associated with a first display device and products A2-N2 are associated with a second display device. One or more products or category of products contained in each zone may therefore be used to select which advertising content to deliver to each display device. As will be described in additional detail herein, the system 200 maintains a mapping of products or categories of products to display zones/display devices in order to effectively select the advertising content that is to be delivered to each display device.

The region managers 135 are coupled to a session manager 215 via a wired or wireless connection. When a region manager 135 detects a new marker 210 entering a detection region 205 that the region manager is monitoring, the region manager generates and transmits a message to the session manager 215. The message contains a marker identifier (a “marker ID”) and a detection region identifier (a “region ID”) to notify the session manager of the presence of the marker within the detection region. When the region manager 135 subsequently detects that the marker has entered a display zone 212 that is within the detection region 205, the region manager 135 generates and transmits a hypertext transfer protocol (HTTP) request to the session manager 215. The HTTP request contains the marker ID and a display zone identifier (a “zone ID”) to notify the session manager of the presence of the marker within the display zone. The HTTP request also serves as a request for the session manager to provide advertising content for presentation on the corresponding display device 125 that is contained within the display zone.

When it receives an HTTP request from a region manager 135, the session manager 215 performs two actions. The session manager 215 identifies and delivers relevant advertising content to the appropriate display device 125 for presentation to the consumer. The advertising content is targeted to the consumer based on the display zone in which the consumer is located (and the corresponding product, groups of products, or categories of products associated with that zone) and any known or predicted information about that consumer, if the consumer is identifiable (e.g., prior purchases made by the consumer, current purchases anticipated being made by the consumer based on selected coupons, demographic information about the consumer, etc.).

To enable targeting of advertising content, the session manager 215 is coupled to a number of databases that store information about the display zone and consumer. The session manager 215 is coupled to a zone mapping database 218, which contains information about each of the display zones in the retail environment. The zone mapping database 218 may contain, for example, for each display zone: (i) information about the location of the zone in the retail environment; (ii) the type of the display device 125 (e.g., screen size, graphics capabilities, type of consumer controls); (iii) an address of the display device so that advertising content may be directed to the display device; and (iv) an identification of the product, products, or categories of products within or associated with the display zone. The zone mapping database 218 is indexed via the zone identifier (zone ID), which uniquely identifies each display zone within a particular retail establishment. The session manager 215 is also coupled to a consumer profile database 220, which maintains various information about any consumers that are capable of being tracked across multiple visits to the retail environment. The consumer profile database 220 may contain, for example, for each consumer: (i) the marker ID associated with the consumer; (ii) any demographic information that is known or predicted about the consumer, such as the gender, age, or income bracket of the consumer; and (iii) a record of past purchases and purchase behavior of the consumer. The consumer profile database 220 is indexed via the marker ID that is associated with each consumer (e.g., via a marker ID associated with a store loyalty card that is held by a consumer, via a marker ID that is associated with a mobile device of a consumer). The session manager 215 is also coupled to a session database 225. The session database 225 maintains a record of all region or zone events that are associated with a consumer during a visit to the retail environment. A region or zone event may be, for example, (i) the entry of the consumer into or exit from a detection region (as reflected by the detection of the marker associated with the consumer), (ii) the entry of the consumer into or exit from a display zone (as reflected by a determination that the location of the marker within the detection region places the marker within the display zone); (iii) the presentation of an advertisement to the consumer in a display zone; (iv) an action of the consumer taken with respect to a display device, such as a request for an additional advertisement or the selection of a coupon; (v) the redemption of a coupon during the checkout process; and (vi) any other details of the checkout process (e.g., the payment instrument, the identity of products purchased or returned, etc.). A set of region and zone events associated with a consumer's visit is referred to herein as a session log, and may be stored or deleted following the consumer's visit. Such a session log may begin, for example, when a shopping cart leaves a shopping cart holding area or when a new marker is first detected within the retail environment. The session log may end when the marker is detected at a check-out area, or when a threshold period of time has elapsed without detecting a marker in a detection region thereby suggesting that the marker has left the retail establishment. The session database 225 is typically indexed by marker ID, region ID, zone ID, session ID, or any of the other fields that are maintained in the session database.

As will be described in additional detail herein, data obtained by the session manager 215 from the zone mapping database 218, the consumer profile database 220, and the session database 225 are utilized to select the advertising content to present to consumers within the identified display zone. The session manager 215 is coupled to a local ad storage area 230 which contains advertising content that is associated with the products or categories of products that are available at the retail establishment. Based on the stored display zone and consumer information, the session manager 215 selects one or more advertisements for presentation to the consumer. The session manager 215 then transmits the selected advertising content to the appropriate display device 125 via an HTTP response. The session manager 215 is able to send messages to, and receive messages from, display devices 125 within each detection region using a wired or wireless protocol. For example, a session manager 215 may communicate with a display device 125 using WiFi or another wireless communication protocol. As another example, a session manager may communicate with a display device across a wired network. As will be described herein, the session manager 215 coordinates the presentation of the received advertising content to consumers via the display devices 125.

The advertising content that is stored in the local ad storage area 230 may be periodically updated by the session manager 215. The session manager is coupled via a public or private network 235 to an advertising aggregator 240. The advertising aggregator 240 periodically accesses or crawls remote services 205a, 250b, . . . 250n to identify advertising content that may be presented to consumers. The remote services may be Internet advertising syndicators (e.g., Google, Microsoft, AOL, etc.), advertising agencies or agents (e.g., WPP or RazorFish), or manufacturers of products or providers of services (e.g., Johnson & Johnson, Proctor and Gamble, General Mills, Coleman, etc.). Advertising content that is identified by the advertising aggregator 240 is stored in a remote ad storage area 245. On a periodic basis, the advertising aggregator 240 transmits new advertising content to the session manager 215 to replace or supplement existing advertising content that is contained in the local ad storage area 230. Advertising content in the local ad storage area may be removed when the content has expired or when the performance of the advertising content falls below a threshold performance level. In addition, the advertising aggregator 240 may compare the performance of advertising content stored in the local ad storage area 230 and being used by the session manager 215 with the anticipated performance of new advertising content stored in the remote ad storage area 245. If the new advertising content is expected to perform better (as measured by, for example, conversion or revenue payable to the operator of the system 200) than the advertising aggregator 240 transmits new advertising content to replace some or all of the advertising content. The analysis of the performance of advertising content may be performed on a periodic (e.g., daily, weekly, monthly) or aperiodic (e.g., when new advertising content is obtained) basis.

In addition to managing the delivery of advertising content via HTTP responses to the display devices, the session manager 215 also maintains a session log that is associated with each marker 210 that is present within the retail environment. Each session log is a record of all region or zone events that are associated with the corresponding marker during a defined timeframe (typically measured as a shopping session or a consumer's visit to the retail establishment). As a marker 210 is carried through the retail environment by a consumer, the session manager 215 maintains a record of all detection region and display zone events that are associated with the marker. For example, the session manager 215 stores a record of the marker's entry into different detection regions, entry and exit into display zones within a region, exit from detection regions, and dwell times in each region or zone in the session log that is associated with the marker. In addition, the session manager 215 maintains a record of any advertising content that is presented on a display device 125 while the marker is present in the corresponding display zone. The session manager 215 also maintains a record of any consumer interactions with the display devices 125, such as requesting a coupon or requesting additional information about a product or category of product. Finally, the session manager 215 maintains a record of all check out or payment events associated with the marker, such as the purchase of particular products or the use of coupons or other offers during a payment process.

Those skilled in the art will appreciate that some or all communications between system 200 components and external services, and some or all of the data contained in the data storage areas, may be encrypted or otherwise secured to protect any confidential or other proprietary information that is managed or used by the system. For example, personally-identifiable information such as names, addresses, demographic information, etc. may be encrypted in order to minimize the likelihood that the data can be accessed by unauthorized third parties.

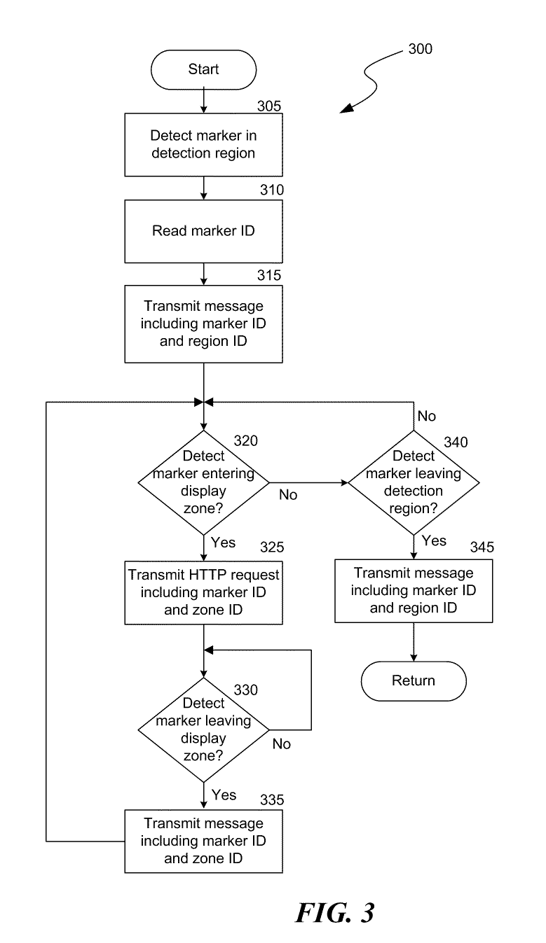

FIG. 3 is a flow diagram of a process 300 implemented by the region managers 135 to detect a detection region or display zone event associated with a consumer 105, and to generate an HTTP request for the delivery of relevant advertising content to a display device 125 in response to any display zone events. At a block 305, the region manager 135 detects a marker 210 in the detection region that is monitored by the region manager. The marker 210 may be detected by an active or passive sensor that detects the presence of the marker. For example, as previously discussed, if the marker is an RFID tag the region manager detects the presence of the RFID tag using an RFID reader. Since markers move through the store under the motive force of consumers, the detection of a marker signals to the region manager 135 the likely presence of a consumer 105 within the region manager's region. (Exceptions might occur, for example, if a cart were to be pushed away from a consumer and travel into a detection region on its own. Such exceptions are a rarity, however, and in most cases are followed by a consumer entering the detection region to retrieve the cart.)

At a block 310, the region manager 135 reads an identifier associated with the marker. The marker ID is a reference number or other code that allows the system to uniquely identify the marker 210 and thereby track the movement of the marker (and, by implication, the associated consumer) throughout the retail environment. Such tracking is accomplished by detecting when a marker enters a region or zone and when a marker leaves the region or zone. The series of region and zone detection events allows the session manager 215 to maintain an accurate record of the regions and zones visited by the consumer during a particular session. Moreover, the speed of the consumer may be estimated by dividing the known region or zone size by the transit time that it took for the marker 210 to traverse the region or zone. By monitoring the direction and speed of the marker 210 though the regions and zones, it is possible for the session manager 215 to predict the likely next region or zone that the consumer will enter based on the path of the consumer.

At a block 315, the region manager 135 constructs a message that is to be sent to the session manager 215 to notify the manager that a marker 210 (and presumably, a corresponding consumer) has entered the detection region. The message contains a region ID, which indicates the detection region in which the marker 210 was detected, as well as the marker ID, which indicates the identity of the marker that was detected. In addition, the message may include the time that the marker was initially detected entering the region. It will be appreciated that a greater or lesser amount of information may be contained in the initial message to the session manager.

Once the marker 210 has entered the detection region, the region manager 135 monitors the location of the marker 210 within the region to determine whether the marker enters a display zone within the region or whether the marker leaves the detection region. (Depending on the configuration of the detection region and the one or more display zones within the detection region, a marker may or may not pass through a display zone before leaving the detection region.) At a decision block 320, the region manager determines whether the marker has entered a display zone, and at a decision block 340, the region manager determines whether the marker has left the detection region. The region manager does so by comparing the current location of the marker with the locations of display zones in the detection region in order to determine whether the current marker location indicates that the marker falls within a display zone. If the test at decision block 320 indicates that the marker has entered a display zone, then processing continues to a block 325. At block 325, the region manager 135 transmits an HTTP request to the session manager 215 to request the delivery of advertising content to the display 125 that is contained in or associated with the display zone. The following is a representative format of an HTTP request constructed and transmitted by the region manager:
GET/path/script.cgi?marker_id=value1&display_zone_id=value2 HTTP/1.1 Host: www.visablebrands.com:80

The request contains a zone ID (value2), which indicates the display zone in which the marker 210 was detected, as well as the marker ID (value1), which indicates the identity of the marker that was detected. The Host address is the IP Address (or name) of the session manager. In addition, the HTTP request may include the time that the marker was initially detected entering the display zone. It will be appreciated that a greater or lesser amount of information may be contained in the HTTP request, depending on the amount of information that is required by the session manager 215 to identify advertising content for presentation to a consumer. An advantage of using a HTTP request is that it extends a protocol normally only used in the online world (i.e., in the networked computer environment), to the physical environment of brick-and-mortar stores. By utilizing requests formatted in accordance with the HTTP protocol, the region manager 135 is more easily integrated with pre-existing online services, such as advertising networks.

After transmission of the HTTP request for advertising content, processing continues to a block 330. At block 330, the region manager 135 monitors the location of the marker 210 to determine whether the marker has exited the display zone. When the marker has exited the display zone, processing continues to a block 335 where the region manager 135 sends an message to the session manager 215 to indicate to the session manager that the marker (and presumably the consumer) is no longer in the display zone. The message contains a marker ID, to indicate the identity of the marker, and the zone ID, to indicate the display zone that the marker just exited. In addition, the message may include the time that the marker was detected as leaving the display zone. It will be appreciated that a greater or lesser amount of information may be contained in the message to the session manager. When the marker 210 has left a display zone adjacent to display device 125, the likelihood that the consumer associated with the marker is still watching or listening to the advertising is substantially reduced.

After sending a message to the session manager 215 indicating that the marker has left the display zone, processing returns to decision blocks 320 and 340 where the region manager 135 continues to monitor the location of the marker to determine whether the marker re-enters the same display zone, enters a different display zone, or leaves the detection region. If at decision block 320 it is detected that the marker has re-entered the same display zone or entered a different display zone, the processing in blocks 325-335 is repeated. If, however, the region manager 135 determines that the marker has left the detection region in decision block 340, processing continues to block 345. At block 345, the region manager 135 sends a message to the session manager 215 to indicate to the session manager that the marker (and presumably the consumer) is no longer in the detection region. The message contains a marker ID, to indicate the identity of the marker, and the detection region ID, to indicate the detection region that the marker just exited. In addition, the message may include the time that the marker was detected as leaving the detection region. It will be appreciated that a greater or lesser amount of information may be contained in the message to the session manager.

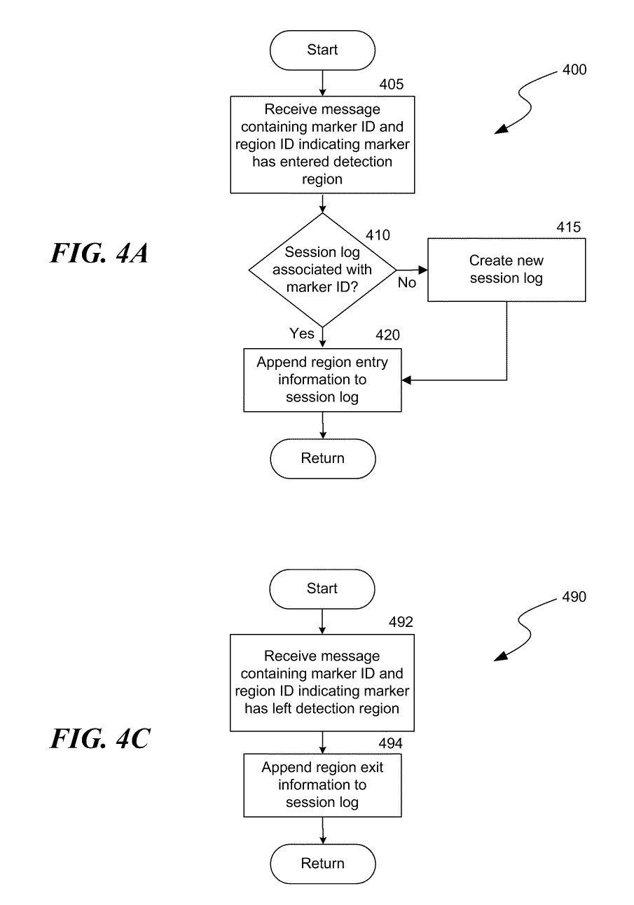

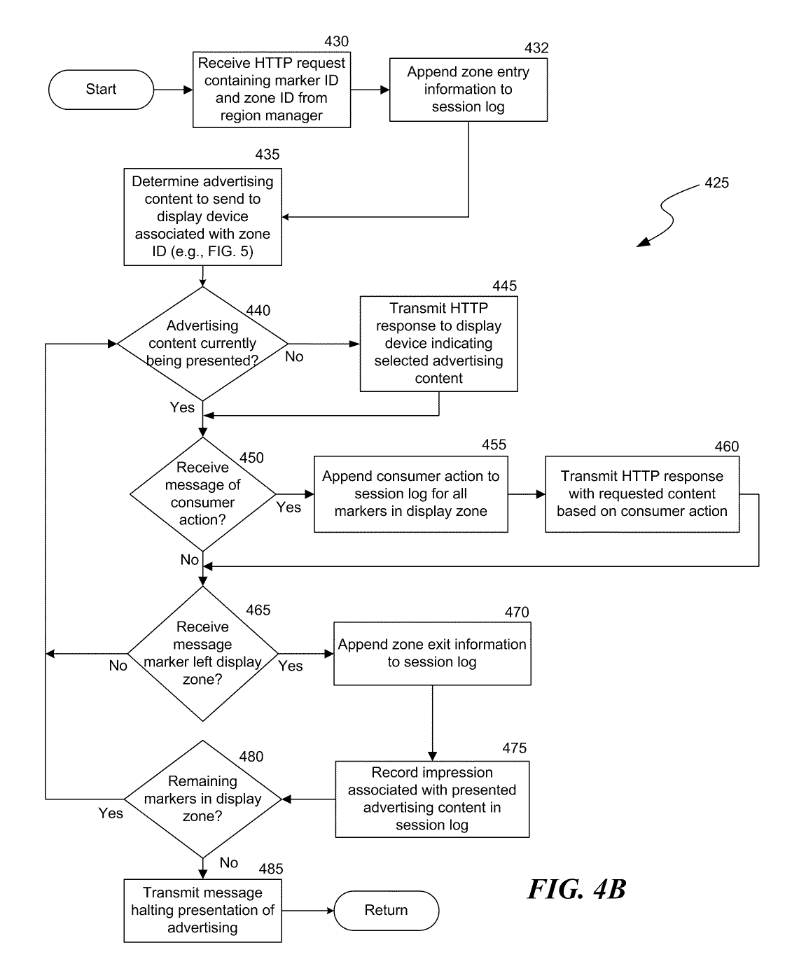

FIGS. 4A-4C are flow diagrams of processes implemented by the session manager 215 to receive and process region or zone events that are sent by the region manager 135. FIG. 4A is a flow diagram of a process 400 implemented by the session manager to receive and process a message indicating that a marker has entered a detection region monitored by the region manager 135. At a block 405, the session manager receives a message that contains the marker ID of the detected marker, as well as the region ID that identifies the region in which the marker was detected. At a decision block 410, the session manager 215 determines whether there is a session log associated with the received marker ID. If no session log is currently associated with the marker ID, at a block 415 the session manager 215 creates a new session log and assigns the session log to the received marker ID. If, however, a session log is already associated with the marker ID at decision block 410, processing continues to a block 420.

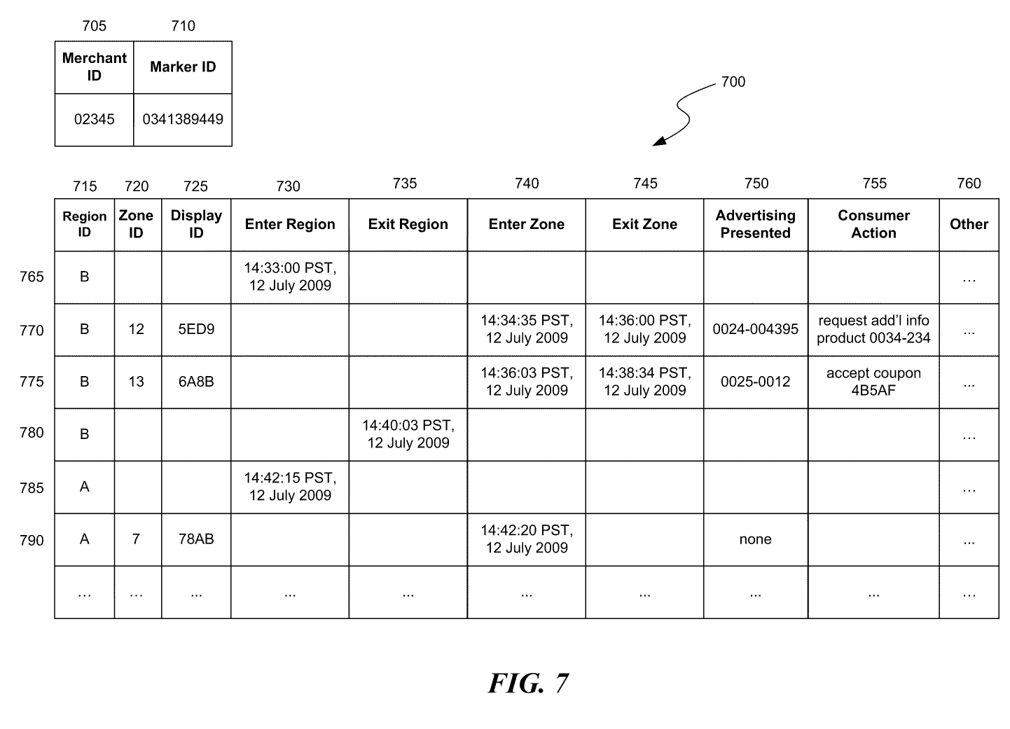

At block 420, the received region ID and other information is appended to the session log. The session log thereby contains a record of the region event, namely the initial detection of a particular marker in the region at a certain date and time. The construction and contents of the session log will be discussed in further detail herein with respect to FIG. 7. Once the region event reflecting entry of a marker into a region has been recorded in a session log, the process 400 is complete.

FIG. 4B is a flow diagram of a process 425 implemented by the session manager 215 to receive an HTTP request from the region manager 135, determine advertising content to present to the consumer, and transmit the advertising content to the appropriate display device 125 via an HTTP response. At a block 430, the session manager 215 receives an HTTP request for advertising content that is sent from a region manager 135. The HTTP request contains the marker ID of the detected marker, as well as the zone ID that identifies the zone in which the marker was detected. At block 432, the received zone ID and other information is appended to the session log. The session log thereby contains a record of the zone event, namely the entry of a particular marker into a display zone at a certain date and time. In addition, the session log contains a record of the zone ID, which allows the session manager to determine the one or more products or categories of products that are contained in or associated with the display zone. The construction and contents of the session log will be discussed in further detail herein with respect to FIG. 7.

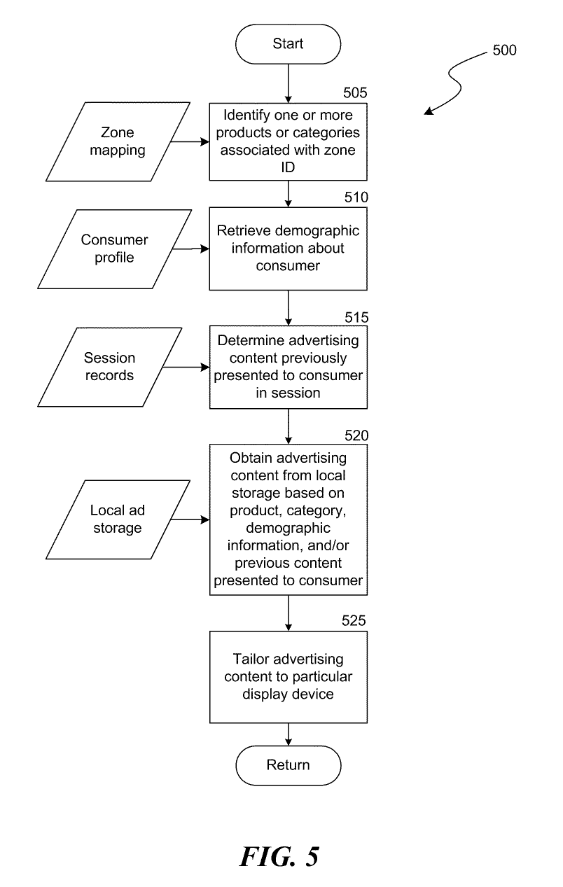

After appending the zone event to the session log, at a block 435 the session manager 215 determines the advertising content that is to be sent to a display device 125 for presentation to the consumer. To determine which advertising content to send to the display device, the session manager executes a selection process 500 such as is depicted in FIG. 5. FIG. 5 is a flow diagram of the process 500 to select relevant advertising content for presentation to the consumer based on the received HTTP request. At a block 505, using the received zone ID, the session manager 215 identifies one or more products or categories of products that are contained in or associated with the entered zone. The products or categories of products are identified from the zone mapping database 115 that is maintained by the session manager.

At a block 510, using the received marker ID, the session manager 215 retrieves any demographic information that is known about the consumer. The demographic information is contained in the consumer profile database 220 that is maintained by the session manager 215. If the marker ID is associated with a marker that is constantly being reused by different consumers, such as a marker that is attached to a shopping cart, it may not be possible for the session manager 215 to correlate the marker ID with the identity of a specific consumer. If, however, the marker ID is associated with a marker that is associated with only a single consumer or a small group of consumers, such as a marker that is embedded within a store loyalty card that is carried by one or more members of a family, then the session manager 215 is able to correlate the marker ID with the identity of the consumer and retrieve any demographic information about the consumer. The demographic information may contain, for example, the age, gender, income bracket, and other factors that characterize the consumer. The demographic information may have been obtained by the session manager as a result of, for example, an initial registration process that a consumer completes in order to obtain the store loyalty card.

At a block 515, using the received marker ID, the session manager 215 retrieves any session information that is associated with the marker. The session information may be a current session log that is associated with the marker. The current session log reflects all region and zone events associated with the current visit of the consumer to the retail establishment. For those marker IDs that are associated with the same consumer across more than one session, the session manager 215 may also retrieve past session logs. Past session logs represent prior visits by the consumer to the retail establishment, and are useful because they provide an aggregate record of shopping and purchasing behavior by the consumer.

At a block 520, the session manager 215 utilizes the information about the products and categories of products in the zone, any consumer profile information, information about current and past zone events that are associated with the consumer, and other factors (e.g., the current calendar date, the current weather, current events that may influence buying behavior) to select one or more pieces of advertising content that are to be presented to the consumer. The advertising content is selected to be targeted to a potential purchase that the consumer might make in or adjacent to the present zone. The advertising content will therefore typically relate to the products or category of products in or adjacent to the display zone, or to complementary or related products or categories of products. For example, if the consumer is in a grocery store and in an aisle where canned soup is being sold, the session manager 215 may select an advertisement for Campbell's tomato soup for presentation to the consumer. Alternatively, the session manager 215 may select a complementary product to soup to advertise, such as crackers. The selected advertisement may have a video element that is presented to the display, as well as a coupon that the consumer may select if they are interested in making a purchase of Campbell's soup. If the consumer has a tendency to linger in zones for extended periods (e.g., if the average dwell time of the associated marker 210 is long), then the session manager 215 may select multiple pieces of advertising content for presentation to the consumer.

Advertising content is typically selected by the session manager 215 from advertising content stored in the local ad storage area 230. Selecting advertising content from the local ad storage area is advantageous because there is low latency (i.e., the session manager does not need to wait for a response to an external service request), because the particular advertising content stored in the local ad storage area may be tailored to the particular retail establishment (e.g., advertising content may be selected that is targeted to the local demographic of consumers in different merchant stores), and because it allows the retail establishment to pre-empt national advertising campaigns with its own campaigns more easily. In some circumstances, however, there may be no advertising content that is stored locally that is suitable for presentation to consumers in a particular display zone. For example, advertising content stored in the local ad storage area may have expired and no recent updates may have been received from the advertising aggregator 240. As another example, there may have been no advertisements stored in the local ad storage area that pertain to the products associated with the display zone. In these and other circumstances, the session manager 215 may make a direct call to one or more advertising syndicators (e.g., Google, Microsoft, AOL, etc.), to advertising agencies or agents (e.g., WPP or RazorFish), or directly to manufacturers of products or services (e.g., Johnson & Johnson, Proctor and Gamble, General Mills, Coleman, etc.). The requested syndicator, agency, or advertiser may then reply in real-time or near real time with advertising that should be presented to consumers in the particular display zone. Because the initial request for advertising content that is received by the session manager 215 is formatted in accordance with the HTTP protocol, the request received from the region manager 135 may be directly forwarded to the advertising syndicator, agency or other ad provider with little or no required formatting changes. As a result, the system disclosed herein allows the brick and mortar environment to take advantage of the advertising content and brokering that has become so robust in the World Wide Web.

At a block 525 the session manager 215 may tailor the selected advertising content for the display device 125 on which the selected advertising content will be presented. In some circumstances, a retail establishment may utilize display devices having different technical characteristics and capabilities. For example, some display devices may have color screens while others may have black and white, some display devices may be optimized for the display of video while others may be optimized for the display of text, some display devices may have a speaker to allow sound to accompany advertising content while others may not have a speaker, etc. In other situations, the session manager may optimize the content for presentation on the particular display device. Such optimization may include selection of one format of advertising content over another if multiple formats are available, or may include transformation of the advertising content such as by changing the resolution of the advertising content.

Returning to FIG. 4B, after selection of the advertising content to transmit to the display device at block 435, processing continues to a decision block 440. At decision block 440, the session manager 215 determines whether any advertising content is currently playing on the display device 125 that is to receive the newly-selected advertising content. Because the region manager 135 transmits an HTTP request for advertising content each time that a new marker 210 is detected in a display zone, and because the session manager 215 responds by selecting new advertising content to present on the display device 125, it is possible that advertising content may already be playing on a display device when new advertising content is selected for transmission by the session manager. For example, if three consumers having markers all enter a display zone, the session manager will select at least three pieces of advertising content that are to be displayed on the display device in the display zone. To resolve such a scheduling conflict, the session manager 215 implements a FIFO algorithm, meaning that the selected piece of advertising content for the first detected marker is played and that the other pieces of advertising content are queued for presentation after the preceding pieces of advertising content are finished. If advertising content is therefore currently playing on the intended display device 125 at decision block 440, the session manager allows the currently playing piece of advertising content to continue to conclusion. If, however, no advertising content is currently playing on the display device 125 at decision block 440, processing continues to a block 445.

At block 445 the session manager 215 transmits an HTTP response to the display device 125 (i.e., the display device associated with the zone ID that was contained in the region manager's initial request for advertising content). The HTTP response contains the advertising content that was identified by the session manager 215 as being appropriate for presentation to the consumer in the zone. In some embodiments, rather than transmitting the advertising content, the session manager 215 transmits a link or other pointer to the advertising content so that that the display device 125 may retrieve the advertising content from the local ad storage area 230 directly.

In some embodiments, the session manager 215 may also transmit the HTTP response containing advertising content to other display devices 125 in addition to the display device this is associated with the display zone in which the marker 210 is detected. For example, in FIG. 1B, Region F contains three display devices 125 that are in proximity to each other. Certain advertisers may prefer that their advertising content run on all three display devices simultaneously, particularly if Region F covers a common product category. To allow the simultaneous display of advertising content on multiple display devices, the session manager maintains business rules that define groups of display devices and identifies the circumstances under which each group should be used. For example, all of the display devices 125 in Region F may be specified as being in a group so that the entry of a marker into any of the three display zones causes the same advertising content to be simultaneously presented on each display of the group. As another example, only certain advertisers may be willing to pay the increased advertising fees associated with presenting advertising content on more than one display device, so the business rules may specify which advertising content is only presented on one display device and which advertising content is presented on a group of display devices. The business rules allow the groups to be dynamically defined, modified, and deleted as specified by the system operator. When the same advertising content is to be displayed on multiple display devices, the session manager 215 merely transmits the same HTTP response containing the desired advertising content to the specified display devices.

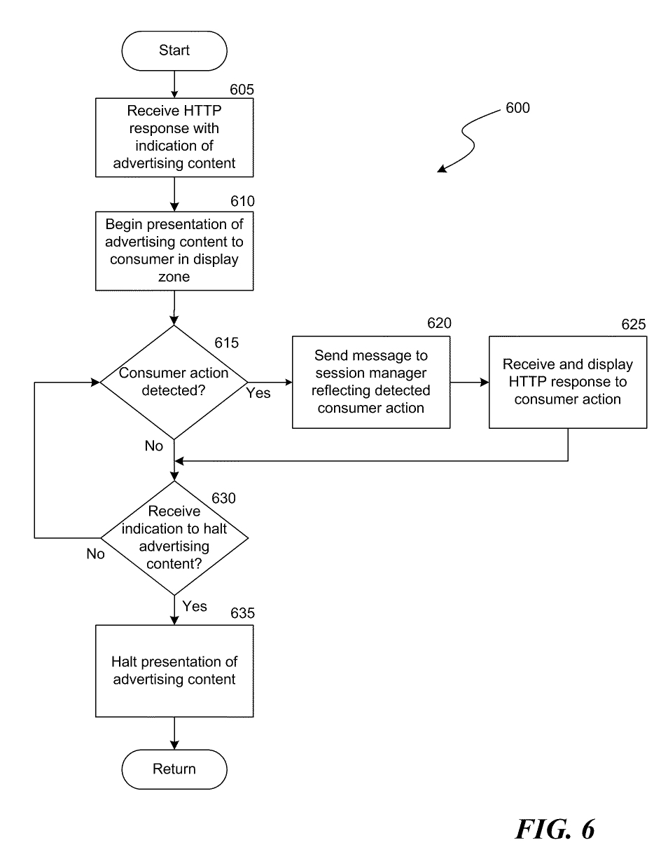

After the advertising content is transmitted to the display device 125 (or display devices), the advertising content is presented on the display device 125 (or devices). FIG. 6 is a flow diagram of a process 600 that is executed by a display device 125 to receive the HTTP response from the session manager 215 and present the selected advertising content to one or more consumers. At a block 605, the display device receives the HTTP response from the session manager 215 which includes the advertising content or a link to the advertising content that is to be presented. At a block 610 the display device begins to present the advertising content to any consumers that are presumed to be in the display zone by the existence of markers in the display zone.

As advertising content is being presented on the display device 125, the display device is checking to see if any consumer action is detected by the display device or if any further content or commands are received from the session manager 215. Such consumer action may be the selection of a button on the display device to accept a product offer (e.g., receive a coupon, select a 2-for-1 deal, receive a discount on a second product with the purchase of a first product, etc.), to see additional information about the displayed product, to request another advertisement, etc. At a decision block 615, the display device determines if a consumer action is detected such as, for example, by the selection of a button contained on the display device. If consumer action is detected at decision block 615, processing continues to a block 620. At block 620, the display device 125 sends an message to the session manager 215 to indicate that the detected consumer action. The message contains a description of the consumer action to allow the session manager to record the action in a session log. Because the consumer action is captured in the session log associated with the marker 210, the system 200 is able to take subsequent action on the recorded action, such as by redeeming a selected coupon during a checkout process or tailoring subsequent advertising based on an improved understanding of the consumer's interests. At a block 625, the display device receives an HTTP response from the session manager 215 which indicates that the consumer action has been recorded. The HTTP response may also include content to display to the consumer, such as a message indicating that a coupon has been recorded as being associated with the marker, or a message providing the additional information (e.g., recipes, related products, nutritional information) that was requested by the consumer action. At block 625, the display device therefore presents any provided content to consumers in the display zone. Processing then continues to a decision block 630.

In addition to constantly checking to see if any consumer action is detected by the display device 125, the display device continues to receive and act on commands from the session manager 215. One of the commands that the display device implements is to halt the presentation of advertising content. The advertising content may be halted, for example, when the region manager 135 determines that all markers have left the display zone that is associated with the display device. At decision block 630, the display device determines whether a command has been received from the session manager 215 to halt the display of advertising content. If a command has not been received, processing continues to decision block 615 where the display device again determines whether a consumer action has been detected. If a command to halt advertising content has been received, processing continues to block 635 where the display device halts the advertising content that is currently being presented. After the advertising content is halted, the display device returns to a quiescent state where it waits to receive new advertising content for display to consumers.

Returning to FIG. 4B, after transmitting advertising content to a display device for presentation to consumers, the session manager 215 enters a monitoring state where it receives indications of consumer actions from the display device 125 that is presenting the advertising content, or indications of a further event associated with the corresponding display zone from the region manager 135. At a decision block 450, the session manager checks to see whether it has received a message indicating that a consumer action has been detected by the display device. If a message has been received processing continues to a block 455. Otherwise, processing continues to decision block 465.

At block 455, the session manager 215 appends the indicated consumer action to the session log of each marker 210 that is currently present in the display zone. In those situations where only a single marker is contained in the display zone, the session manager may reasonably assume that the consumer action was made by the consumer associated with the single marker. Multiple markers in the display zone, however, imply the presence of multiple consumers in the zone. In those situations where multiple markers are present in the display zone, it may be impossible for the display device to detect which particular consumer is associated with the action because of monitoring limitations of the display device. In such situations, the consumer input is recorded by the session manager 215 as being associated with all markers in the zone. That is, the consumer action is appended by the session manager onto a session log associated with each marker in the zone. Although some inaccuracy in recording consumer action results from this approximation, it ensures that the consumer that actually performed the action is appropriately recorded as having done so. In addition to recording the received consumer action in the appropriate session log, at a block 460 the session manager 215 transmits an HTTP response to the display device containing any requested content that is responsive to the detected consumer action. Processing then continues to decision block 465.

At decision block 465, the session manager 215 determines whether a message has been received from the region manager 135 that indicates that a marker 210 that was formerly in the display zone has now left the zone. The message includes the marker ID so that the session manager is apprised of the identity of the marker. Much as the region manager 135 is able to determine when a new marker enters the display zone, the region manager monitors the location of markers in the detection region in order to determine when a marker leaves the display zone. To perform such monitoring, the region manager 135 may periodically detect or compute the position of each marker to ensure that it continues to remain within the boundaries of the display zone. If the session manager does not receive an indication that a marker has left the display zone (i.e., all markers remain in the display zone), then processing returns to decision block 440 where the session manager determines whether new advertising content needs to be sent to the display device. If, however, the session manager receives an indication that a marker has left the display zone at decision block 465, processing continues to block 470. At block 470, an indication that the marker has left the display zone is recorded in the session log. By recording when the marker has left the display zone, the session manager is able to compute the marker's dwell time in the display zone by subtracting the entry time of the marker into the display zone from the exit time. The dwell time in the display zone may be used by the session manager to compute the speed of the marker by dividing the width of the transited zone by the dwell time.

After recording that the marker has left the display zone at block 470, at a block 475 the session manager records an impression in the session log indicating that the consumer associated with the marker was exposed to advertising content. If advertising content is presented on a display device when a consumer is in a display zone, it is likely that the consumer is exposed to the advertising content. The system therefore records an impression of the presented advertising content so that the advertiser may be charged for the impression. The impression recorded in the session log includes an indication of the advertising content that was presented to the consumer, since the session manager 215 tracks the advertising content that was sent to the display device for presentation to consumers. When an impression of the advertising content has been recorded in the session log, processing continues to decision block 480.

As an alternative to automatically recording an impression when a consumer is in a display zone and advertising is presented on the display device, the session manager 215 may instead condition the recordation of an impression on whether the marker has exceeded a threshold dwell time in the zone. If a marker transits a display zone too quickly, it might imply that the consumer associated with the marker was in a hurry or was interested in areas of the retail environment other than the area containing the zone. In such a case, it is unlikely that the consumer either would have been interested in the presented advertising content or would have been exposed to a sufficient amount of the presented advertising content to make an impression on the consumer. If, however, a consumer lingers in a display zone, it is likely that the consumer would have been exposed to the advertising content since the advertising content was presented while the consumer was actively shopping in that zone. While the threshold dwell time may vary widely depending on the size of the display zone and the identity of the products or categories of products associated with the zone, a threshold dwell time of four or five seconds may be the minimum period for an impression to be made. In an alternate implementation, if the transit time of the marker exceeds the threshold dwell time, the session manager records an impression in the session log associated with the marker since the consumer was likely exposed to the advertising content. In contrast, if the transit time of the marker does not exceed the threshold dwell time, the session manager does not record an impression of any advertising content in the session log, since the consumer did not dwell within the display zone for a sufficient period of time. It will be appreciated that the threshold dwell time may be adjusted by the session manager depending on the average length of the advertising content that is presented to consumers or the desired dwell time that an advertiser would prefer to see before an advertising impression is recorded.

At decision block 480, the session manager 215 determines whether any other markers 210 (and hence consumers) remain in the zone. If markers remain in the zone, processing returns to decision block 440 where a decision is made as to the advertising content that should be presented to the consumers. If, however, it is determined that no markers remain in the zone at decision block 480, processing continues to block 485. At block 485, the session manager 215 halts the presentation of advertising content on the display device 125. With no markers present, it is unnecessary to continue to present advertising content to an empty zone. Halting the display of advertising content also “resets” the display so that it is ready to present new advertising content when a new marker is detected as having entered a zone.

FIG. 4C is a flow diagram of a process 490 implemented by the session manager 215 to receive and process a message indicating that a marker has exited a detection region monitored by a region manager 135. At a block 492, the session manager receives a message that contains the marker ID of the detected marker, as well as the region ID that identifies the region that the marker just exited. At block 494, the received region ID and other information is appended to the session log. The session log thereby contains a record of the region event, namely the exit of the marker from the region at a certain date and time. Once the region event reflecting exit of a marker from the region has been recorded in a session log, the process 490 is complete. By recording both the entry time of a marker into a region and the exit time of a marker from the region, the session manager is able to calculate dwell time and rate of travel through any region in the retail establishment.

The session manager 215 stops recording events in the session log and “closes” the session log when it detects a condition that indicates the end of the consumer's visit to the retail establishment. For example, the detected condition may be the presence of the marker in a region that is associated with a checkout area. As another example, the detected condition may be a lengthy presence of the marker in a single region, such as might occur if a consumer abandons a shopping cart and exits a retail establishment. As yet another example, the detected condition may be a purchase action by the consumer (e.g., the tendering of a credit card to pay for purchases) at the retail establishment. When such a condition is detected, the session manager may record a terminal event indicating the end of the session. If the marker is associated with a unique consumer, the session log may then be stored for that consumer. If the marker is not associated with a unique consumer, the session log may be stored in a fashion that allows aggregate analysis of the session log with other anonymous consumers.

In summary, the session manager 215 receives a number of different types of region and zone event notifications from region managers 135 and display devices 125 within a retail establishment. The session manager 215 receives messages from the region manager 135 indicating then a marker has entered and exited a region. The session manager 215 receives an HTTP request when a marker has entered a display zone and a message when the marker has exited the display zone. The session manager also receives one or more messages from display devices 125 indicating consumer actions that were received on a display device 125. All such requests and messages are typically received asynchronously from the region managers and display devices throughout the retail establishment as events are detected. Each of the received events will typically result in event data being appended by the session manager 215 to the appropriate session log. In this fashion, the session manager maintains an accurate record of all events that occur in the retail establishment and allows subsequent mining of the session logs to improve advertising effectiveness.

FIG. 7 is a representative session log 700 for storing session data associated with the region and zone events of a consumer. Each row in the session log 700 reflects one or more events that are associated with a marker 210. Each column in the session log 700 reflects one or more details of the event that is being tracked. All session logs are associated with a particular merchant and a particular marker. A “merchant ID” field 705 contains an identification number (“02345”) that uniquely identifies the retail environment that contains the zone. A “marker ID” field 710 contains the identification number of the marker that is being tracked. The first three columns of the session log 700 contain information that pinpoints the location of the marker. A “region ID” column 715 contains an identifier (e.g., region “B”) that uniquely identifies the detection region within the particular retail environment. A “zone ID” column 720 contains an identifier (e.g., zone “12”) that uniquely identifies the display zone within the particular retail environment. And a “display ID” column 725 contains an identifier (e.g., “5ED9”) that uniquely identifies each display device. The first three columns of the session log thereby allow the session manager 215 to track within an advertising network where a particular event takes place.

The next four columns of the session log 700 contain information that characterizes the marker's transit of a region or a zone. An “enter region” column 730 contains a time and date stamp that reflects when the marker ID was first detected in the identified region. An “exit region” column 735 contains a time and data stamp that reflects when the marker ID was detected has having exited the region. An “enter zone” column 740 contains a time and date stamp that reflects when the marker ID was first detected in the identified zone. An “exit zone” column 745 contains a time and data stamp that reflects when the marker ID was detected has having exited the zone. It will be appreciated that a region dwell time or a zone dwell time may be calculated by subtracting the appropriate enter time from the exit time, or may be determined by a timer that is started and stopped by a session manager.

The remaining columns of the session log 700 contain information that characterizes activities that occur within a display zone. An “advertising presented” column 750 contains a record of all advertising content that was presented while a marker 210 was within the identified display zone. Advertising content is identified by a unique reference (e.g., “0024-004395”) so that the session manager is able to track the performance of particular pieces of advertising content across multiple session logs. As was discussed with respect to FIG. 6, an impression of the advertising content is recorded if the marker is in the display zone when the advertising content is presented on the associated display device. While it is common for only a single piece of advertising content to be presented to a consumer in a zone, if a consumer dwells within a zone for an extended period, two or more pieces of advertising content may be identified in the advertising presented column 750. In some circumstances, of course, no advertising content may be presented in a particular display zone, such as when no advertising content is available for presentation in the zone. A “consumer action” column 755 records any consumer actions that are capable of being captured by a display device. For example, the consumer action column may contain an indication of an offer that the consumer selected (e.g., “accept coupon 4B5AF”) or a request for additional product information that is made by the consumer. Of course, additional columns 760 may be added to the session log 700 by the session manager to support additional data that the system finds it useful to track.

Various region and zone events are depicted as being stored in the session log 700 of FIG. 7. For example, row 765 is a region entry event, since it contains an identifier of a region and a time of region entry. Row 770 reflects several display zone events, including the entry into a display zone (display zone 12), the presentation of an advertisement to the consumer, the recordation of a consumer action, and the exit from the display zone. Row 775 reflects several display zone events in a different display zone (display zone 13) as that reflected by row 770, but within the same region (region B). Row 780 reflects a region exit event, since it contains an identifier of a region and a time of region exit. Row 785 reflects a region entry event into a different region (region A). And row 790 reflects display zone events within a display zone (display zone 7) of the different region.

Those skilled in the art will appreciate that the system 200, session manager 215, and region managers 135 may be implemented on any computing system or device. Suitable computing systems or devices include personal computers, server computers, hand-held or laptop devices, multiprocessor systems, microprocessor-based systems, programmable consumer electronics, network devices, minicomputers, mainframe computers, distributed computing environments that include any of the foregoing, and the like. Such computing systems or devices may include one or more processors that execute software to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one dr more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

Although the region manager 135 and display 125 were introduced and discussed herein as being separate components, it will be appreciated that the region manager and display may be combined into a single unit. When combined into a single unit, the detection region and the display zone may cover the same area. In other words, the area that is monitored by the region manager 135 may be coincident with the area in which a consumer is likely to see a piece of advertising content that is presented to the consumer on the display device.

Although the various components in the system 200 were described as transmitting and receiving requests and responses using the HTTP protocol, it will be appreciated that in certain implementations a mobile messaging protocol may be used for messaging in lieu of the HTTP protocol. For example, the region manager 135, session manager 215, and display devices 125 may exchange communications using messaging formatted in accordance with a short message service (SMS) protocol, an ICQ (instant messaging) protocol, or a similar protocol. In such embodiments, each of the components of the system includes appropriate communication modules to enable messaging in accordance with the selected protocol. By using requests and responses formatted in accordance with common messaging protocols, the disclosed system may easily integrate with existing advertising services or content that are available via mobile messaging platforms

Those skilled in the art will also appreciate that the actual implementation of each database may take a variety of forms, and the phrase “database” is used herein in the generic sense to refer to any area that allows data to be stored in a structured and accessible fashion using such applications or constructs as relational databases, object databases tables, flat files, linked lists, arrays, and so on. Those skilled in the art will further appreciate that the depicted flow charts may be altered in a variety of ways. For example, the order of the steps may be rearranged, steps may be performed in parallel, steps may be omitted, or other steps may be included. While FIG. 7 depicts a session log whose contents and organization are designed to make them more comprehensible by a human reader, those skilled in the art will appreciate that the actual data structure(s) used by the system to store this information may differ from the log shown, in that it, for example, may be organized in a different manner, may contain more or less information than shown, may be compressed and/or encrypted, and may be optimized in a variety of ways.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A computer-implemented method of delivering advertising content to display devices in a retail environment, the computer-implemented method comprising:
maintaining a mapping of a plurality of zones in a retail environment, each of the plurality of zones having a display device and defined as an area in which a consumer can perceive advertising content presented on the display device, wherein each of the plurality of zones are associated with one or more products or categories of products;
receiving an HTTP request from a requesting component in response to the detected entry of a marker into one of the plurality of zones, the marker being associated with a consumer and characterized by a marker identifier, the HTTP request conveying the marker identifier and identifying the zone in which the marker was detected;
utilizing the identified zone to retrieve from the mapping a product or category of product that is associated with the zone;
selecting advertising content for presentation on the display device in the identified zone based on the identified product or category of product that is associated with the identified zone;
generating an HTTP response to the HTTP request, the HTTP response containing an indication of the selected advertising content associated with the identified product or category of product that is to be presented on the display device in the identified zone to the consumer; and
transmitting the HTTP response to the display device, the HTTP response causing the presentation of the selected advertising content to the consumer.

2. The computer-implemented method of claim 1, wherein the HTTP request further comprises a time stamp indicating the first detected entry of the marker into the identified zone

3. The computer-implemented method of claim 1, wherein the zone is identified by a zone identifier in the HTTP request.

4. The computer-implemented method of claim 1, wherein the zone is identified by an address of the display device in the zone.

5. The computer-implemented method of claim 1, wherein the requesting component is a region manager.

6. The computer-implemented method of claim 5, wherein the region manager is incorporated in a display device.

7. The computer-implemented method of claim 1, wherein selecting advertising content for presentation in the identified zone further comprises making a selection based on the marker identifier.

8. The computer-implemented method of claim 1, wherein the advertising content is selected from a local storage area.

9. The computer-implemented method of claim 1, wherein the advertising content is selected from Internet-accessible advertising aggregators.

10. The computer-implemented method of claim 1, wherein the advertising content is received directly from advertisers.

11. The computer-implemented method of claim 1, wherein the entry of the marker in one of the plurality of zones is determined by tracking a location of the marker by detecting a radio frequency identification (RFID) tag associated with the marker and wherein the marker identifier is an RFID tag number.

12. The computer-implemented method of claim 1, further comprising receiving an indication of a consumer action in the identified zone.

13. The computer-implemented method of claim 12, wherein the consumer action is an acceptance of an offer.

14. The computer-implemented method of claim 13, wherein the offer is a coupon.

15. The computer-implemented method of claim 12, wherein the consumer action is a request for additional product information.

16. The computer-implemented method of claim 12, wherein the consumer action is a request for an additional piece of advertising content.

17. The computer-implemented method of claim 12, further comprising transmitting an HTTP response to the display device, the HTTP response containing information responsive to the consumer action.

18. The computer-implemented method of claim 1, further comprising:
receiving a message from the requesting component in response to the detected exit of the marker from the identified zone, the message conveying the marker identifier.

19. The computer-implemented method of claim 18, further comprising:
recording an impression of the selected advertising content presented on the display device during the period that the marker is in the identified zone.

20. The computer-implemented method of claim 1, further comprising:
identifying one or more additional display devices that are to present the advertising content; and
transmitting the HTTP response to the identified one or more additional display devices, the HTTP response causing the presentation of the selected advertising content to the consumer.

21. A system for delivering advertising content to display devices in a retail environment, the system comprising:
a plurality of region managers associated with a plurality of regions, each of the plurality of regions having one or more zones that each contain a display device, a zone being defined as an area in which a consumer can perceive advertising content presented on the display device and each zone being associated with one or more products or categories of products, each of the region managers monitoring a corresponding region to detect the location of a marker in the region, wherein upon detecting a marker entering a zone, the region manager:
generates an HTTP request containing a marker identifier associated with the marker and the zone identity; and
transmits the HTTP request to a session manager to request advertising content for presentation on the display device in the zone to a consumer; and
a session manager in communication with the plurality of region managers, the session manager receiving a HTTP request transmitted by a region manager, and in response to the received HTTP request:
utilizing the identity of the zone to retrieve a product or category of products that is associated with the zone;
selecting advertising content for presentation on the display device in the zone based on the retrieved product or category of products that is associated with the zone;
generating an HTTP response to the HTTP request, the HTTP response containing an indication of the selected advertising content associated with the identified product or category of product that is to be presented on the display device in the zone to the consumer; and
transmitting the HTTP response to the display device in the zone;
wherein the transmitted HTTP response causes the selected advertising content to be presented to the consumer.

22. The system of claim 21, wherein the HTTP request further comprises a time stamp indicating a first detected presence of the marker in the identified zone

23. The system of claim 21, wherein the identity of the zone is specified by a zone identifier in the HTTP request.

24. The system of claim 21, wherein the identity of the zone is specified by an address of the display device in the zone.

25. The system of claim 21, wherein selecting advertising content for presentation on the display device in the zone further comprises making a selection based on the marker identifier.

26. The system of claim 21, wherein the advertising content is selected from a local storage area.

27. The system of claim 21, wherein the advertising content is selected from Internet-accessible advertising aggregators.

28. The system of claim 21, wherein the advertising content is received directly from advertisers.

29. The system of claim 21, wherein the location of the marker in one of the plurality of zones is determined by the region manager detecting a radio frequency identification (RFID) tag associated with the marker and wherein the marker identifier is an RFID tag number.

30. The system of claim 21, wherein at least one of the display devices is capable of detecting an indication of a consumer action in the corresponding zone.

31. The system of claim 30, wherein the consumer action is an acceptance of an offer.

32. The system of claim 31, wherein the offer is a coupon.

33. The system of claim 30, wherein the consumer action is a request for additional product information.

34. The system of claim 30, wherein the consumer action is a request for an additional piece of advertising content.

35. The system of claim 30, wherein the display device further transmits a message to the session manager with an indication of the consumer action, and wherein the session manager further transmits an HTTP response to the display device, the HTTP response containing information responsive to the consumer action.

36. The system of claim 21, wherein the zone manager further transmits a message to the session manager when it detects a marker exiting the zone based on the location of the marker, the message conveying the marker identifier.

37. The system of claim 36, wherein the session manager further records an impression of the selected advertising content presented on the display device during the period that the marker is in the identified zone.

38. The system of claim 21, wherein the session manager further:
identifies one or more additional display devices that are to present the advertising content; and
transmits the HTTP response to the identified one or more additional display devices, the HTTP response causing the presentation of the selected advertising content to the consumer.

39. A computer-implemented method of requesting and receiving advertising content for presentation on a display device in a retail environment, the computer-implemented method comprising:
detecting the location of a marker in a region, wherein the detected marker implies the presence of a consumer in the region;
determining when the location of the marker in the region indicates that the marker has entered into an identified display zone from one or more display zones that are contained in the region, each of the display zones being associated with a display device;
generating an HTTP request in response to the detected presence of the marker in the identified display zone, the HTTP request containing the marker identifier and identifying the display device in the display zone;
transmitting the HTTP request to a session manager to request advertising content for presentation on the display device in the identified display zone;
receiving an HTTP response from the session manager, the HTTP response containing an indication of advertising content that is to be presented on the display device in the identified display zone to the consumer, wherein the advertising content is selected by:
utilizing the identified display zone to retrieve a product or category of product that is associated with the display zone; and
selecting the advertising content based on the identified product or category of product that is associated with the display zone; and
causing the presentation of the selected advertising content on the identified display device to the consumer.

40. The computer-implemented method of claim 39, wherein the HTTP request further comprises a time stamp indicating a time when the marker was first detected in the identified display zone

41. The computer-implemented method of claim 39, wherein the identified display zone is identified by a zone identifier in the HTTP request.

42. The computer-implemented method of claim 39, wherein the identified display zone is identified by an address of the display device.

43. The computer-implemented method of claim 39, wherein the advertising content is further selected based on the marker identifier.

44. The computer-implemented method of claim 39, wherein the advertising content is selected from Internet-accessible advertising aggregators.

45. The computer-implemented method of claim 39, wherein the advertising content is selected from a local storage area.

46. The computer-implemented method of claim 39, wherein the advertising content is received directly from advertisers.

47. The computer-implemented method of claim 39, wherein the location of the marker in the region is determined by detecting a radio frequency identification (RFID) tag associated with the marker and wherein the marker identifier is an RFID tag number.

48. The computer-implemented method of claim 39, further comprising detecting an indication of a consumer action in the identified zone.

49. The computer-implemented method of claim 48, wherein the consumer action is an acceptance of an offer.

50. The computer-implemented method of claim 49, wherein the offer is a coupon.

51. The computer-implemented method of claim 48, wherein the consumer action is a request for additional product information.

52. The computer-implemented method of claim 48, wherein the consumer action is a request for an additional piece of advertising content.

53. The computer-implemented method of claim 48, further comprising transmitting a message to the session manager with an indication of the consumer action.

54. The computer-implemented method of claim 53, further comprising receiving an HTTP response from the session manager, the HTTP response containing information responsive to the consumer action.

55. The computer-implemented method of claim 39, further comprising:
determining when the location of the marker in the region indicates that the marker has exited the identified display zone; and
generating a message in response to the detected exit of the marker from the identified display zone, the message containing the marker identifier and identifying the display zone that was exited.
